(19) United States
(12) Patent Application Publication
(10) Pub. No.: US 2025/0372688 A1
(43) Pub. Date: Dec. 4, 2025

(54) LASER WELDING APPARATUS FOR SECONARY BATTERY

(71) Applicant: SAMSUNG SDI CO., LTD., Yongin-si (KR)

(72) Inventors: Jung Yeol NOH, Yongin-si (KR); Deok Jo PARK, Yongin-si (KR); Seung Ik CHO, Yongin-si (KR); Seon Young KANG, Yongin-si (KR); Hee Joo LEE, Yongin-si (KR)

(21) Appl. No.: 18/944,550

(22) Filed: Nov. 12, 2024

(30) Foreign Application Priority Data
Jun. 4, 2024 (KR) 10-2024-0072858

(51) Int. Cl. H01M 10/04; B23K 26/21; B23K 26/70; B23K 101/36

(52) U.S. Cl. CPC H01M 10/0404; B23K 26/21; B23K 26/702; B23K 2101/36

(57) ABSTRACT

A laser welding apparatus for a secondary battery is provided, with the laser welding apparatus being configured such that a fixing force for a current collector of a secondary battery is improved. The laser welding apparatus reduces the likelihood of human errors and defects in a process of welding the current collector of the secondary battery.

### CROSS-REFERENCE TO RELATED APPLICATION

The present application claims priority to and the benefit of Korean Application No. 10-2024-0072858, filed on Jun. 4, 2024, in the Korean Intellectual Property Office, the entire disclosure of which is incorporated by reference herein.

### BACKGROUND

### 1. Field

Embodiments relate to a laser welding apparatus for a secondary battery, and more particularly, to a laser welding apparatus for a current collector of a medium to large sized secondary battery.

### 2. Description of the Related Art

Secondary batteries are chargeable and dischargeable batteries, unlike primary batteries that are not be rechargeable. In the case of a low-capacity battery in which a single secondary battery is packaged in a pack form, the secondary battery can be used in small portable electronic devices such as mobile phones and camcorders. In the case of medium to large sized batteries in which a plurality of secondary batteries are assembled in a module form, the secondary batteries can be used as power sources for driving motors in hybrid vehicles and electric vehicles, or as batteries for energy storage devices.

A secondary battery is provided by embedding an electrode assembly that includes a separator that is an insulator and is interposed between a positive electrode plate and a negative electrode plate and an electrolyte into a case and then by installing a cap plate on the case. An example of the electrode assembly is a jelly-roll type assembly. The jelly roll-type electrode assembly is provided with a main tab or a non-coating portion protruding upward or in a left or right direction, and a terminal is connected to the main tab or non-coating portion.

Korean Patent Publication No. 10-2020-0102177 discloses an example of a second battery with an electrode assembly.

The above-described information disclosed in the background technology of this disclosure is only intended to improve understanding of the background of the present disclosure and therefore may include information that does not constitute prior art.

### SUMMARY

Embodiments of the present disclosure provide a laser welding apparatus for a secondary battery, which has a structure that ensures a more stable fixing force for a current collector of the secondary battery to be welded with the laser welding apparatus.

However, the technical objects to be solved by the present disclosure are not limited to the objects described above, and other objects that are not mentioned can be clearly understood by those skilled in the art from the present disclosure.

According to some embodiments, a laser welding apparatus for a secondary battery includes: a shielding jig configured to be attachable to and detachable from the laser welding apparatus; a positioning plate configured to attach the shielding jig to the laser welding apparatus; and a pocket forming part protruding from sides of a surface of the positioning plate.

In the laser welding apparatus for the secondary battery, the shielding jig may be configured to move vertically with respect to the surface of the positioning plate.

In the laser welding apparatus for the secondary battery, the shielding jig may be configured to slidably move on the surface of the positioning plate.

In the laser welding apparatus for the secondary battery, the pocket forming part may include: a first pocket forming part protruding from a first side of the surface of the positioning plate; and a second pocket forming part protruding from a right side of the one surface of the positioning plate.

In the laser welding apparatus for the secondary battery, a receptacle space may be defined in the one surface of the positioning plate by the first pocket forming part and the second pocket forming part, and wherein the shielding jig may be configured to be accommodated in the receptacle space.

In the laser welding apparatus for the secondary battery, an inner edge shape of the pocket forming part may match an outer edge shape of the shielding jig such that an inner edge surface of the pocket forming part and an outer edge surface of the shielding jig contact each other.

In the laser welding apparatus for the secondary battery, an end of the pocket forming part may have a width that is wider than an upper end of the pocket forming part.

In the laser welding apparatus for the secondary battery, the shielding jig may include first and second hook parts extending from two sides of an upper portion of the shielding jig.

In the laser welding apparatus for the secondary battery, the first and second hook parts may be fitted to be in close contact with a top surface of the pocket forming part.

In the laser welding apparatus for the secondary battery, the laser welding apparatus may further include: a shielding nozzle part on a rear surface of the positioning plate; and at least one close contact part configured to fix the shielding nozzle part to the shielding jig.

In the laser welding apparatus for the secondary battery, the close contact part may be a rotating clamp.

In the laser welding apparatus for the secondary battery, the rotating clamp may include a round head bolt and a nut so that the rotating clamp and the shielding jig are connected to each other with a bolt-nut fastening structure.

In the laser welding apparatus for the secondary battery, the laser welding apparatus may be configured such that a current collector of the secondary battery may be in close contact with the welding apparatus in a direction of a front surface of the welding apparatus.

A method of welding a current collector to a second battery includes using the laser welding apparatus to laser-weld a current collector of a secondary battery to another part of the secondary battery.

In the laser welding apparatus for the secondary battery, the laser welding apparatus may further include: a shielding nozzle part on a rear surface of the positioning plate; and at least one close contact part configured to fix the shielding nozzle part to the shielding jig, wherein the close contact part may be configured to generate point contact when rotating with respect to a portion of the positioning plate.

In the laser welding apparatus for the secondary battery, the close contact part may include a bolt-nut fastening structure.

A method of welding current collectors in a secondary battery include using the laser welding apparatus to laser weld first and second current collectors that are connected to first and second electrode tab parts connected to the electrode assembly, respectively, to other parts of the secondary battery.

the first electrode tab part may include at least two first electrode tabs, and the second electrode tab part may include at least two second electrode tabs, wherein the first electrode tabs extend in opposite directions and the second electrode tabs extend in opposite directions.

According to other embodiments, a laser welding apparatus is provided for laser-welding a current collector of the secondary battery to another component of the secondary battery, the laser welding apparatus comprising: a shielding jig configured to be attachable to and detachable from the laser welding apparatus such that the current collector of the secondary battery is fixed to the laser welding apparatus; a positioning plate configured to attach the shielding jig to the laser welding apparatus; and a pocket forming part protruding from sides of a surface of the positioning plate.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain principles of the present disclosure. In the drawings:

FIG. 1 is a schematic perspective view of an outer appearance of a prismatic type secondary battery on which laser welding is performed using a laser welding apparatus for a secondary battery according to embodiments;

FIG. 2 is a cross-sectional view of the secondary battery of FIG. 1;

FIG. 3A is a transverse cross-sectional view of the secondary battery of FIG. 1, and FIG. 3B is a transverse cross-sectional view of the secondary battery of FIG. 3A according to other embodiments;

FIG. 4A is a schematic perspective view of an electrode assembly within the secondary battery of FIG. 1, and FIG. 4B is a schematic cross-sectional view of the electrode assembly within the secondary battery of FIG. 4A according to other embodiments;

FIG. 5A is an enlarged view of a portion A of FIG. 3;

FIG. 5B is a schematic view of a bonding structure between one electrode tab and a first current collector of FIG. 4B;

FIG. 6A is a schematic view of a welding process for electrically connecting a first current collector to a first electrode tab in the secondary battery;

FIG. 6B is a schematic view of a welding process for electrically connecting a first current collector to a first electrode tab in the secondary battery;

FIG. 7A is a schematic view of a process of laser-welding the bonding structure of FIG. 5A;

FIG. 7B is a schematic view of a process of laser-welding a second electrode tab and a second current collector in the bonding structure of FIG. 5A;

FIG. 8 is a schematic perspective view of a state in which a shielding jig is detached in a laser welding apparatus including a shielding jig according to the related art;

FIG. 9 is an enlarged view of a state in which the shielding jig is attached to the laser welding apparatus according to the related art;

FIG. 10 is a schematic perspective view of a state in which a shielding jig is attached in the laser welding apparatus including the shielding jig according to other embodiments;

FIG. 11 is a front view from the shielding jig of the laser welding apparatus of FIG. 8; and

FIG. 12 is a front view from the shielding jig of the laser welding apparatus of FIG. 10.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

A laser welding apparatus for a secondary battery according to embodiments may be used for welding a current collector of a medium or large sized battery.

The medium to large sized battery may be provided as a high-power prismatic type or pouch-type secondary battery. The battery also may be provided as a battery pack including a plurality of pouch-type secondary batteries, which has advantages in terms of easy stacking, lightweight, and ability to include a large number of batteries.

In this specification, for the convenience of explanation, the laser welding apparatus for a secondary battery will be described mainly with reference to its use in manufacturing prismatic type medium to large sized secondary batteries. However, the laser welding apparatus according to the present disclosure is not limited to production of prismatic type secondary batteries and may be applied to various types of batteries.

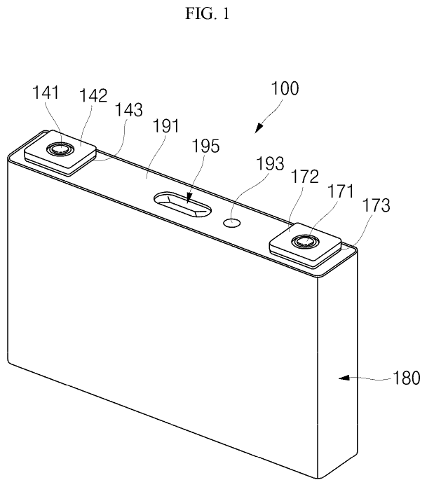

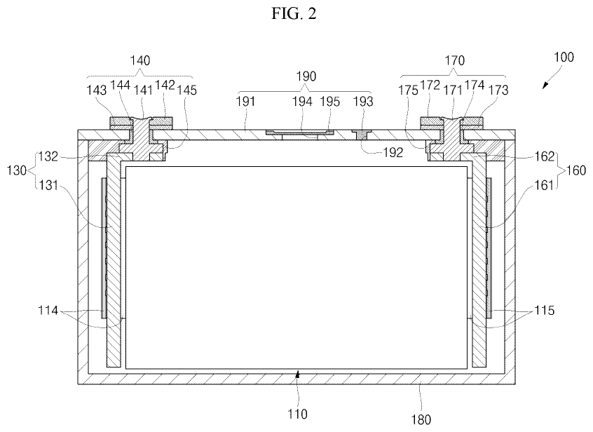

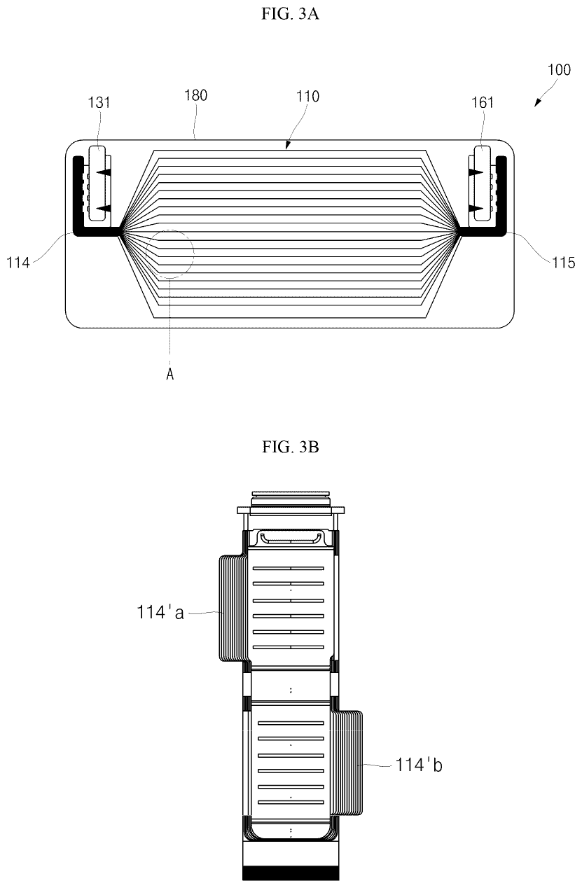

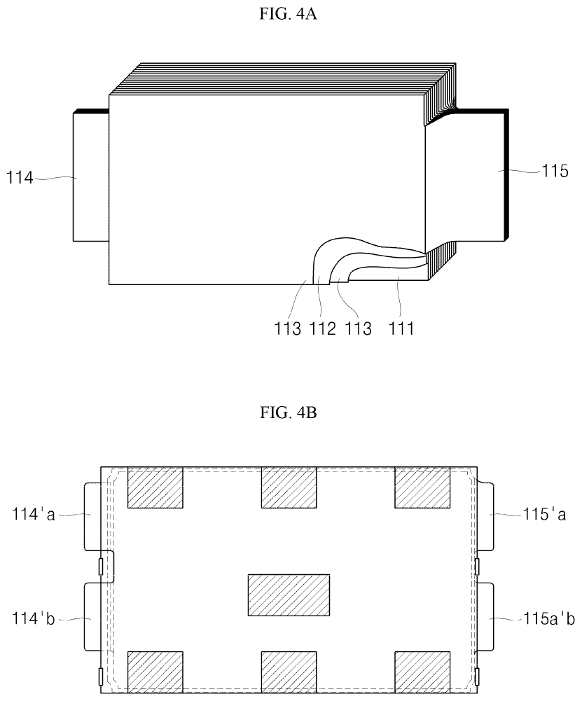

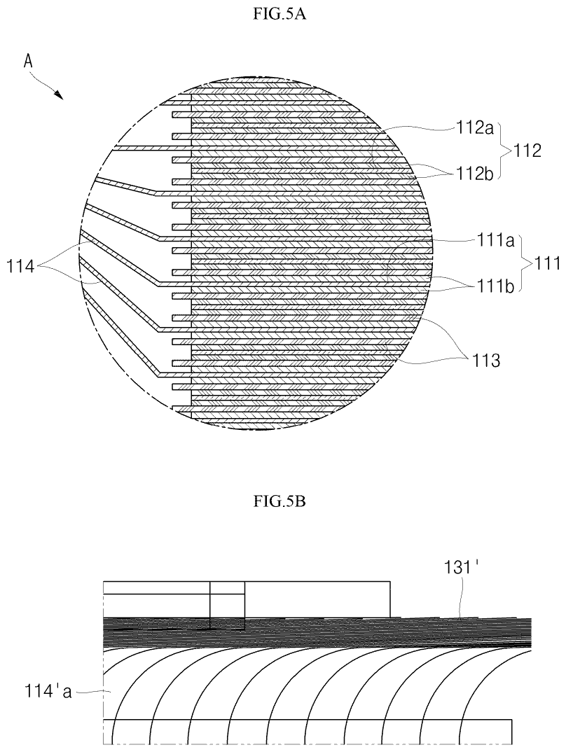

FIG. 1 is a schematic perspective view of the outside of a prismatic type secondary battery 100 in which laser welding is performed using a laser welding apparatus for a secondary battery according to embodiments. FIGS. 2 and 3A are cross-sectional and transverse cross-sectional views of the secondary battery 100, respectively. FIG. 4A is a schematic perspective view of an electrode assembly 110 within the secondary battery 10, and FIG. 5A is an enlarged view of a portion A of FIG. 3A.

The secondary battery 100 may include a stack type electrode assembly 110 having a jelly-roll shape, a fist current collector 130 electrically connected to one side of the electrode assembly 110, for example, a first electrode tab 114. A first terminal 140 may be electrically connected to the first current collector 130. A second current collector 160 may be electrically connected to the other side of the electrode assembly 110, for example, a second electrode tab 115. A second terminal 170 may be electrically connected to the second current collector 160. A case 180 accommodates the electrode assembly 110, and a cap assembly 190 is coupled to an opening of the case 180.

The electrode assembly 110 may be provided in a stacked form of first electrode plates 111, second electrode plates 112, and separators 113 interposed between the first and second electrode plates 111 and 112.

A configuration of the electrode assembly 110 will be described in more detail with reference to FIGS. 4A and 5A. The electrode assembly 110 may be if forms other than a wound jelly-roll shape. For example, the electrode assembly may be provided in a rectangular parallelepiped shape in which prismatic first electrode plates 111, prismatic separators 113, and prismatic second electrode plates 112 are sequentially stacked, with the first electrode tab 114 and the second electrode tab 115 protrude to form opposite sides of the electrode assembly. Each of the first electrode tab 114 and the second electrode tab 115 may have a thickness of about 0.4 mm to about 0.7 mm.

In some embodiments, the first electrode plate 111 may operate as a negative electrode, and the second electrode plate 112 may operate as a positive electrode. In other embodiments, the first electrode plate 111 may operate as a positive electrode, and the second electrode plate 112 may operate as a negative electrode. In the present disclosure, for convenience of explanation, an example in which the first electrode plate 111 operates as the negative electrode, and the second electrode plate 112 operates as the positive electrode, will be described.

The first electrode plate 111 may be formed by applying a first electrode active material 111b such as graphite or carbon to a first electrode current collector 111a made of a metal foil such as copper, a copper alloy, nickel or a nickel alloy and may include a first electrode tab 114 (or first non-coating portion) that is an area on which the first electrode active material is not applied. The first electrode tab 114 may serve as a passage for a current flow between the first electrode plate 111 and the first terminal 140.

In some embodiments, the first electrode tab 114 may protrude by a certain length to one side of the electrode assembly 110 as illustrated in FIG. 3A and may be bent in an approximately “L” shape.

The second electrode plate 112 may be formed by applying a second electrode active material 112b such as transition metal oxide to a second electrode current collector 112a made of a metal foil such as aluminum or an aluminum alloy. The second electrode plate 112 may include a second electrode tab 115 (or second non-coating portion) that is an area on which the second electrode active material 112b is not applied. The second electrode tab 115 may serve as a passage for a current flow between the second electrode plate 112 and the second terminal 150.

In some embodiments, the second electrode tab 115 may protrude by a certain length to one side of the electrode assembly 110 as illustrated in FIG. 3A and may be bent in an approximately “L” shape.

The separator 113 is disposed between the first electrode plate 111 and the second electrode plate 112 to prevent a short circuit and allow the movement of lithium ions. The separator 113 may be formed of polyethylene, polypropylene, or combined film of polypropylene and polyethylene. But the material of the separator 113 is not limited to such materials in the present disclosure.

The electrode assembly 110 may be accommodated in the case 180 together with an electrolyte, but the present disclosure is not limited thereto. The electrolyte may include an organic solvent such as ethylene carbonate (EC), propylene carbonate (PC), diethyl carbonate (DEC), ethyl methyl carbonate (EMC), or dimethyl carbonate (DMC), and a lithium salt such as LiPF₆ or LiBF₄.

The first current collector 130 may include a first electrode connection part 131 that is electrically and mechanically connected to the first electrode tab 114 of the electrode assembly 110, and a first terminal connection part 132 that is bent to extend from an upper end of the first electrode connection part 131 and electrically and mechanically connected to the first terminal 140. In some embodiments, the first electrode connection part 131 and the first electrode tab 114 and/or the first terminal connection part 132 and the first terminal 140 may be coupled through laser welding. A laser welding apparatus for the laser welding will be described in detail below.

Similar to the first current collector 130, the second current collector 160 may include a second electrode connection part 161 that is electrically and mechanically connected to the second electrode tab 115 of the electrode assembly 110, and a second terminal connection part 162 that is bent to extend from an upper end of the second electrode connection part 161 and electrically and mechanically connected to the second terminal 170. In some embodiments, the second electrode connection part 161 and the second electrode tab 115 and/or the second terminal connection part 162 and the second terminal 170 may be coupled through laser welding. A laser welding apparatus for the laser welding will be described in detail below.

The case 180 may be provided in an approximately hollow rectangular parallelepiped shape having an upper portion in which an opening is defined. The electrode assembly 110 may be inserted into the case through the opening. The first current collector 130 and the second current collector 160 may also be disposed inside the case 180.

The cap assembly 190 may first include a cap plate 191 in the form of a flat plate. The cap plate 191 may be made of a thin plate material and be coupled to the opening of the case 180 to seal the opening. The cap plate 191 may include an electrolyte injection part 192 through which electrolyte may be injected into the sealed case 180. The electrolyte injection part 192 may be sealed by a sealing plug 193 after the electrolyte is injected. In addition, the cap plate 191 may include a vent hole 194, and a vent plate 195 that is broken if an internal pressure of the sealed case 180 exceeds a set pressure may be installed in the vent hole 194.

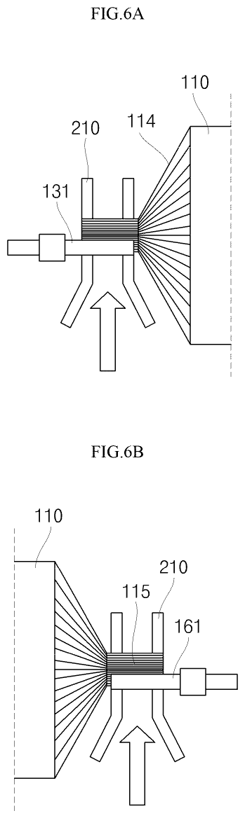

FIG. 6A and FIG. 6B schematically illustrate a welding process of electrically connecting the first current collector and/or the second current collector to the first electrode tab and/or the second electrode tab, respectively.

Referring to FIG. 6A, the first electrode connection part 131 may be positioned to overlap ends of the first electrode tabs 114, and laser welding may be performed on one surface of the overlapping portions. A shielding jig 210 may be used to prevent introduction of foreign substances during the laser welding, thereby ensuring stable welding.

Similarly, referring to FIG. 6B, the second electrode connection part 161 may be positioned to overlap ends of the second electrode tabs 115, and laser welding may be performed on one surface of the overlapping portions. The shielding jig 210 may be used to prevent introduction of foreign substances during the laser welding, thereby ensuring stable welding.

The laser welding process of FIGS. 6A and 6B may be equally applied to the welding for electrically connecting the first current collector and the second current collector to the first terminal and the second terminal, respectively. But for convenience of explanation, duplicated descriptions will be omitted.

In addition, because the laser welding apparatus according to embodiments may also be applied to modified structures of the electrode assembly and the electrode tab, such as those described above, an embodiment of a modified structure will be additionally described below. For convenience of explanation, however, duplicated descriptions are omitted. But it goes without saying that the above-described technical contents can be equally applied to the modified structures as long as they do not conflict with the ideas of the present disclosure.

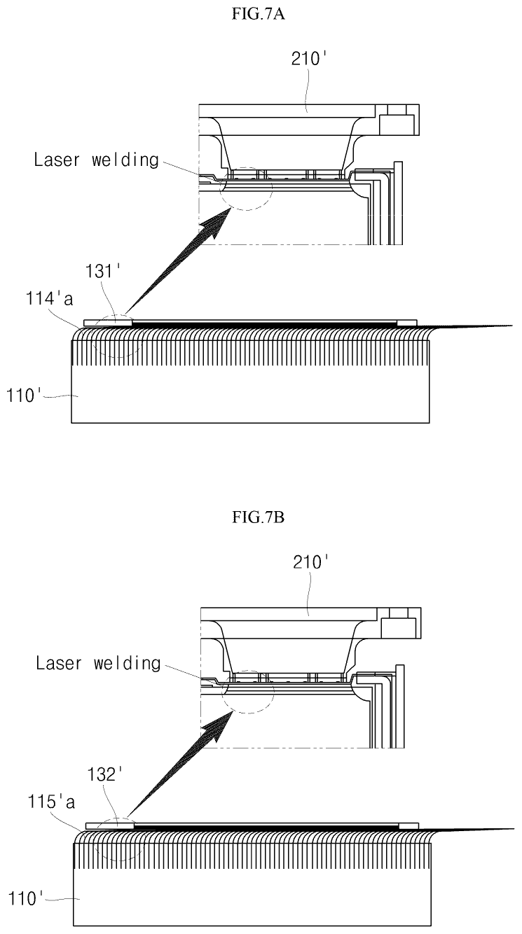

The laser welding process will now be described with reference to FIG. 3B, FIG. 4B, FIG. 5B, FIG. 7A, and FIG. 7B.

FIG. 3Bs a transverse cross-sectional view of the secondary battery of FIG. 3A, FIG. 4Bs a cross-sectional view of the electrode assembly different from that of FIG. 4A, FIG. 5Bs a schematic view of a bonding structure between one electrode tab and the first current collector of FIG. 4B, FIG. 7As a schematic view of a process of the laser-welding the bonding structure of FIG. 5A, and FIG. 7Bs a schematic view of a process of laser-welding one second electrode tab and the second current collector in the bonding structure of FIG. 5A.

There are differences in the embodiments shown in FIGS. 3B, 4B, 5B, and 7B from those in FIG. 3A, etc., particularly with respect to the electrode tab. An electrode structure in which the first electrode tab is not a single electrode tab as in FIG. 3A, but rather the electrode tab is includes one first electrode tab 114′a and a second first electrode tab 114′b is illustrated in FIG. 3B.

The first and second first electrode tabs 114′a or 114′b may extend in different directions, e.g., opposite directions, and also may be bent and symmetrical to each other. As a result, a more stable welding structure may be provided for welding the first electrode tab 114′a or 114′b to the first current collector 131′ as compared to the case in which the electrode tab is a single electrode tab (e.g., FIG. 3A), or a case (not shown) in which all of the first electrode tabs are bent to one side (not shown).

Similarly, an electrode structure in which the second electrode tab is not a single electrode tab but rather includes a first second electrode tab 115′a and a second second electrode tab 115′b is illustrated in FIG. 4B.

The second second electrode tabs 115′a and 115′b may extend in different directions, e.g., opposite directions, and also may be bent and symmetrical to each other. As a result, a more stable welding structure may be provided for welding the second second electrode tab 115′a or 115′b to the first current collector 132′ as compared to the case in which the second electrode tab is a single electrode tab or a case in which all of the second electrode tabs are bent to one side.

If using a shielding jig in the laser welding apparatus, the shielding jig may be detachably connected to the welding apparatus so that the shielding jig can be periodically cleaned to remove foreign substances from the shielding jig, which are generated during the laser welding.

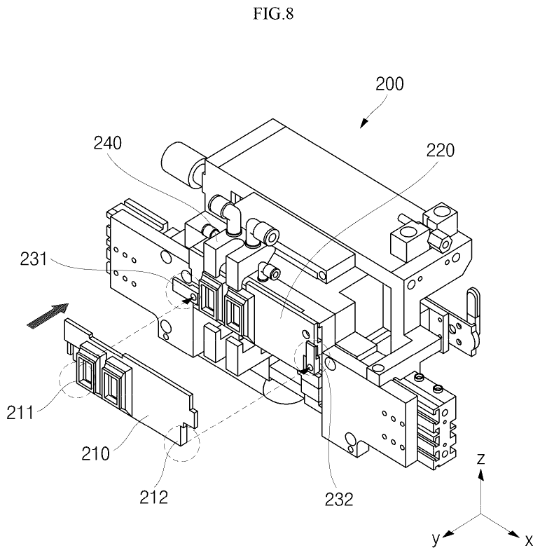

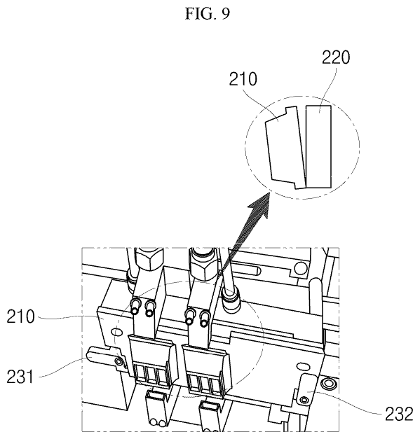

FIGS. 8 and 9 illustrate views of a laser welding apparatus 200 according to the related art. In particular, FIGS. 8 and 9 show a shielding jig 210 assembled to one surface of a positioning plate 220 of the laser welding apparatus 200. Referring to FIG. 8, in attaching or detaching the shielding jig 210 to the positioning plate 220 of the welding apparatus, the shielding jig 210 may be assembled in a direction of the arrow pointing toward the positioning plate 220. In some embodiments, the arrow direction corresponds to a y-axis direction as illustrated in FIG. 8. In addition, first and second spring type fixing parts 231 and 232 provided on lower ends 211 and 212 of the shielding jig 210 and surfaces of the positioning plate 220 may be connected to each other.

The coupling process between the shielding jig and the positioning plate has a disadvantageous limitation in that work time is significantly delayed during the attachment and detachment of the shielding jig.

In some cases, because a coupling part of the shielding jig that is in actual contact with the positioning plate is provided only at the lower ends 211 and 212 of the shielding jig, often the jig is incompletely fixed to the laser welding apparatus during a mounting process. Further, as shown in FIG. 9, even if the shielding jig is properly coupled, a gap may be formed between an upper portion of the shielding jig and the positioning plate. If tilting occurs due to poor coupling between the shielding jig and the positioning plate, there may be poor adhesion between the overlapping parts to be welded and the gap may cause defects due to improper laser welding apparatus nozzle management.

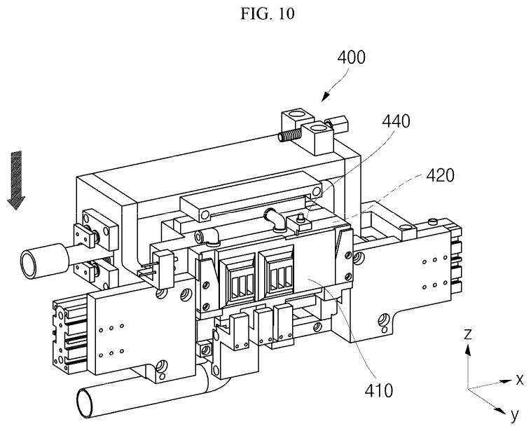

FIG. 10 is a schematic perspective view of a laser welding apparatus 400 according to embodiments of the present disclosure. Referring to FIG. 10, a shielding jig 410 is configured to be assembled in the direction of the arrow, i.e., in a vertical direction with respect to a surface of a positioning plate 420. Because the shielding jig is not attached to the welding apparatus in the direction of the arrow shown in FIG. 9 (front and rear direction; y-axis direction), but rather attached to the welding apparatus in the direction of the arrow shown in FIG. 10 (vertical direction; z-axis direction) adhesion between the shielding jig 410 and the positioning plate 420 may be improved when then the shielding jig 410 is attached to the positioning plate 420. The reason for the improved adhesion may be, but not limited to, a vertical coupling structure between the shielding jig 410 and the positioning plate 420 and/or an increased area that the shielding jig 410 is in contact with the positioning plate 420. The contact area may substantially be an area on which the shielding jig slidably moves on one surface of the positioning plate so as to be in contact with the positioning plate.

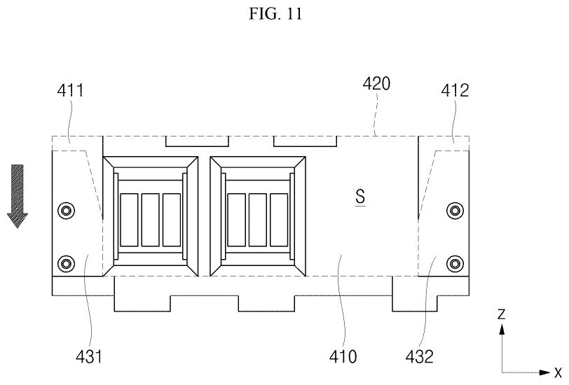

A structure in which the shielding jig is attached to the positioning plate according to embodiments of the present disclosure will be described with reference to FIG. 11. A pocket forming part may fixed to two ends of a surface of the positioning plate 420. The pocket forming part may include a first pocket forming part 431 fixed to a left side as shown in FIG. 11 of the surface of the positioning plate 420 and a second pocket forming part 432 fixed to a right side of the surface of the positioning plate 420. The first and second pocket forming parts 431 and 432 may be configured to protrude from both sides of the surface of the positioning plate to thereby form a receptacle space S in which the shielding jig 410 is accommodated. And the shielding jig 410 may be inserted into the receptacle space S. As shown in FIG. 11, inner edge shapes of the pocket forming parts 431 and 432 may substantially match outer edge shapes of the shielding jig 410, and, thus, the inner edge surfaces of the pocket forming parts 431 and 432 and the outer edge surfaces of the shielding jig 410 may be in contact with each other. Herein, an “edge” may mean an outer edge that defines an outer appearance of the pocket forming part or the shielding jig.

The shielding jig 410 may include a first hook part 411 and a second hook part 412, which extend from both sides an upper portion, i.e., left and right sides shown in FIG. 11. The first hook part 411 and the second hook part 412 may be configured to closely contact a top surface of the first pocket forming part 431 and a top surface of the second pocket forming part 432, respectively.

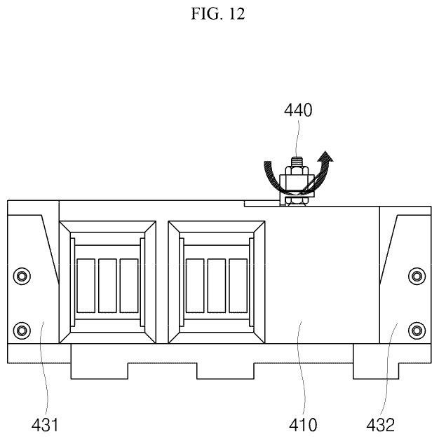

As shown in FIG. 12, a rotating clamp 440 may be provided and configured to further increase the coupling force of the shielding jig 410 in a state in which the shielding jig 410 is attached to the laser welding apparatus 400. The rotating clamp 440 may be applied to the laser welding apparatus according to embodiments to replace a close contact part (e.g., see bolt 240 of FIG. 8) according to the related art. Although not specifically shown, a plurality of rotating clamps may be included, and both rotating clamps and bolts may be utilized. The rotating clamp may be configured to allow a shielding nozzle to closely contact with the positioning plate, as in a nut and bolt connection. For example, the rotating clamp may be configured as a round head bolt, and, thus, the rotating clamp and the shielding jig may be connected to each other through a nut and bolt fastening structure. If the bolt structure is rotated to an upper portion of the positioning plate, surface contact may occur, and a friction area may be large. As a result, there is a possibility that the bolt may loosen. However, the rotating clamp of the laser welding apparatus of the present disclosure may reduce the friction area by generating a point contact if it is rotated with respect to the upper portion of the positioning plate. Thus, the shielding nozzle may be more firmly fixed to the positioning plate.

According to the present disclosure, a laser welding apparatus is provided in which the fixing force for the current collector of the secondary battery is improved. Further, the human errors are minimized with the apparatus to thereby minimize the risk of the welding defects in the current collector of the secondary battery.

The effects achieved with the present disclosure are not limited to those described above, and other technical effects that are not mentioned will be clearly understood by those skilled in the art from this disclosure.

What is claimed is:

1. A laser welding apparatus for a secondary battery, the laser welding apparatus comprising:
a shielding jig configured to be attachable to and detachable from a laser welding apparatus;
a positioning plate configured to attach the shielding jig to the laser welding apparatus; and
a pocket forming part protruding from sides of a surface of the positioning plate.

2. The laser welding apparatus as claimed in claim 1, wherein the shielding jig is configured to move vertically with respect to the surface of the positioning plate.

3. The laser welding apparatus as claimed in claim 2, wherein the shielding jig is configured to slidably move on the surface of the positioning plate.

4. The laser welding apparatus as claimed in claim 1, wherein the pocket forming part comprises:
a first pocket forming part protruding from a first side of the surface of the positioning plate; and
a second pocket forming part protruding from a second side of the surface of the positioning plate that is opposite to the first side of the surface of the positioning plate.

5. The laser welding apparatus as claimed in claim 4, wherein a receptacle space is defined in the surface of the positioning plate by the first pocket forming part and the second pocket forming part, and
wherein the shielding jig is configured to be accommodated in the receptacle space.

6. The laser welding apparatus as claimed in claim 1, wherein an inner edge shape of the pocket forming part matches an outer edge shape of the shielding jig such that an inner edge surface of the pocket forming part and an outer edge surface of the shielding jig contact each other.

7. The laser welding apparatus as claimed in claim 1, wherein an end of the pocket forming part has a width that is wider than an upper end of the pocket forming part.

8. The laser welding apparatus as claimed in claim 1, wherein the shielding jig comprises first and second hook parts extending from two sides of an upper portion of the shielding jig.

9. The laser welding apparatus as claimed in claim 8, wherein the first and second hook parts are fitted to be in close contact with a top surface of the pocket forming part.

10. The laser welding apparatus as claimed in claim 1, further comprising:
a shielding nozzle part on a rear surface of the positioning plate; and
at least one close contact part configured to fix the shielding nozzle part to the shielding jig.

11. The laser welding apparatus as claimed in claim 10, wherein the close contact part is a rotating clamp.

12. The laser welding apparatus as claimed in claim 11, wherein the rotating clamp include a round head bolt and a nut so that the rotating clamp and the shielding jig are connected to each other with a bolt-nut fastening structure.

13. The laser welding apparatus as claimed in claim 1, wherein the laser welding apparatus is configured such that a current collector of the secondary battery may be in close contact with the welding apparatus in a direction of a front surface of the welding apparatus.

14. A method of welding a current collector in a secondary battery, the method comprising:
using the laser welding apparatus as claimed in claim 1, to laser-weld the current collector of the secondary battery to another part of the secondary battery.

15. The laser welding apparatus as claimed in claim 1, further comprising:
a shielding nozzle part on a surface of the positioning plate; and
at least one close contact part configured to fix the shielding nozzle part to the shielding jig,
wherein the close contact part is configured to generate point contact when rotating with respect to a portion of the positioning plate.

16. The laser welding apparatus as claimed in claim 15, wherein the close contact part includes a bolt-nut fastening structure.

17. A method of welding current collectors in a secondary battery, the method comprising:
using the laser welding apparatus as claimed in claim 1 to laser weld first and second current collectors that are connected to first and second electrode tab parts connected to the electrode assembly, respectively, to other parts of the secondary battery.

18. The method as claimed in claim 17, wherein the first electrode tab part comprises at least two first electrode tabs, and the second electrode tab part comprises at least two second electrode tabs, and
wherein the first electrode tabs extend in opposite directions and the second electrode tabs extend in opposite directions.

19. A laser welding apparatus for laser-welding a current collector of the secondary battery to another component of the secondary battery, the laser welding apparatus comprising:
a shielding jig configured to be attachable to and detachable from the laser welding apparatus such that the current collector of the secondary battery is fixed to the laser welding apparatus;
a positioning plate configured to attach the shielding jig to the laser welding apparatus; and
a pocket forming part protruding from sides of a surface of the positioning plate.
